(19) United States
(12) Patent Application Publication
(10) Pub. No.: US 2008/0249979 A1
(43) Pub. Date: Oct. 9, 2008

(54) Method and arrangement for pairing off parties on a labour market

(75) Inventors: Jussi Nurmio, Helsinki (FI); Kari Tervonen, Espoo (FI)

Correspondence Address: YOUNG & THOMPSON, 209 Madison Street, Suite 500, ALEXANDRIA, VA, 22314, US

(73) Assignee: TAIVAS INNOVATIONS OY, HELSINKI (FI)

(21) Appl. No.: 11/783,016

(22) Filed: Apr. 5, 2007

(51) Int. Cl. G06F 7/04

(52) U.S. Cl. 707/2; 707/E17.007

(57) ABSTRACT

The invention provides a method and an arrangement for pairing off a job seeker with potential employers on a labour market. A service provider maintains a database (601) arranged to store labour market data and a server device (602) arranged to connect the database to a data network (603). A job seeker (604) can deliver, via the data network, an earmarking data item that contains information about the job seeker and earmarks a piece of the labour market data. The job seeker can earmark e.g. a vacant job that interests him or her. Therefore, the job seeker does not need to constantly study newspapers or data network announcements. To a potential employer (606), e.g. a company or a private person, who is seeking for suitable human resources, can be given a list of job seekers who have indicated interest in the potential employer.

### FIELD OF THE INVENTION

The invention relates to a method for pairing off a job seeker with a potential employer on a labour market. The invention relates also to an arrangement for pairing off a job seeker with a potential employer on the labour market.

### BACKGROUND

Conventional methods for pairing off job seekers with potential employers on the labour market include newspaper advertisements, advertisements published in a data network, e.g. Internet, and/or presentations organized by a company or another potential employer that is seeking for suitable human resources. There is, however, a considerable risk that a job seeker fails to notice a job advertisement or is not present to hear a presentation concerning a job, which he/she might be interested in. The present data network technology can be used to improve the situation, for example, in such a way that the potential employer that is seeking for human resources can define a job advertisement with constraint requirements, such as a desired education, the desired experience, the working site, the willingness to travel, etc., which an employee should meet. A job seeker can define a search profile and perform a retrieval that yields only those job advertisements that meet the search profile. The job seeker might be interested only in jobs for which, for example, an academic education in certain field is required. Therefore, the job seeker can reduce the number of job advertisements in advance and reduce the number of job advertisements that need to be checked manually. At least in principle, it is possible for a job seeker to place in a newspaper and/or in a data network a job seeking advertisement provided with a description of the job seeker. There is, however, a considerable risk that a potential employer fails to notice a job seeking advertisement placed by a job seeker. In practise, it might be somewhat daunting for a job seeker who already has a job but who is willing to get a new job to place a job seeking advertisement in a public newspaper or in a public data network, because the job seeking advertisement can be seen also by the current employer of the job seeker. Delicacy, discretion, and confidentiality are especially important factors in a situation in which a job seeker who already has a job is seeking for a new-job.

The above-described methods and arrangements for pairing off job seekers and potential employers on the labour market are characterized in that a job seeker and, correspondingly, a potential employer looking for a suitable person must often show considerable activity and diligence in order to achieve a situation in which a right person gets a right job. Consequently, there is a considerable demand for a method and an arrangement, which can be used for seeking for jobs and for seeking for human resources in such a way that the above-mentioned needs for activity and diligence are reduced and a desired level of delicacy, discretion, and confidentiality can be guaranteed.

### SUMMARY

An object of the invention is to provide a new method for pairing off parties on the labour market such that the above-described drawbacks associated with the prior art are reduced or eliminated. A further object of the invention is to provide a new arrangement for pairing off parties on the labour market such that the above-described drawbacks associated with the prior art are reduced or eliminated. A further object of the invention is to provide a new computer program product for pairing off parties on the labour market such that the above-described drawbacks associated with the prior art are reduced or eliminated.

In a method according to the invention for pairing off parties on the labour market a service provider maintains a database arranged to store labour market data and a server device arranged to connect the database to a data network. The method is characterised in that the service provider enables a job seeker to deliver, via the data network to the server device, an earmarking data item that contains information about the job seeker and a logical pointer that earmarks a piece of the labour market data.

An arrangement according to the invention for pairing off parties on the labour market comprises a database arranged to store labour market data and a server device arranged to connect the database to a data network. The arrangement is characterised in that the server device is arranged to enable a job seeker to deliver, via the data network to the server device, an earmarking data item that contains information about the job seeker and a logical pointer earmarking a piece of the labour market data.

A computer program product, embodied in a computer readable medium, for pairing off parties on the labour market comprises computer program means for making a server device to maintain a database arranged to store labour market data and computer program means for making the server device to connect the database to a data network. The computer program product is characterised in that it comprises computer program means for making the server device to enable a job seeker to deliver, via the data network to the server device, an earmarking data item that contains information about the job seeker and a logical pointer earmarking a piece of the labour market data.

A number of embodiments of the invention are described in accompanied dependent claims.

The embodiments of invention provide considerable advantages:
A job seeker can earmark a vacant job, a potential employer, and/or a field of profession that interests him or her. Therefore, the job seeker does not need to constantly study newspapers and data networks.
A job seeker who already has a job can seek for a new job in a confidential manner.
To a potential employer, e.g. a company or a private person, who is seeking for suitable human resources, can be given a list of job seekers who have indicated interest in the potential employer, in a vacant job of the potential employer, and/or in professional fields associated with the potential employer.

Various embodiments of the invention together with additional objects and advantages will be best understood from the following description of specific embodiments when read in connection with the accompanying drawings.

The embodiments of the invention presented in this document are not to be interpreted to pose limitations to the applicability of the appended claims. The verb “to comprise” is used in this document as an open limitation that does not exclude the existence of also unrecited features. The features recited in depending claims are mutually freely combinable unless otherwise explicitly stated.

### BRIEF DESCRIPTION OF THE FIGURES

The invention and its advantages are explained in greater detail below with reference to the embodiments presented in the sense of examples and with reference to the accompanying drawings, in which:

FIG. 1 is a flow chart of a method according to a first embodiment of the invention for pairing off parties on the labour market,

FIG. 2 is a flow chart of a method according to a second embodiment of the invention for pairing off parties on the labour market,

FIG. 3 is a flow chart of a method according to a third embodiment of the invention for pairing off parties on the labour market,

FIG. 4 is a flow chart of a method according to a fourth embodiment of the invention for pairing off parties on the labour market,

FIG. 5 is a flow chart of a method according to a fifth embodiment of the invention for pairing off parties on the labour market, and

FIG. 6 shows an arrangement according to an embodiment of the invention for pairing off parties on the labour market.

### DETAILED DESCRIPTION OF THE EMBODIMENTS

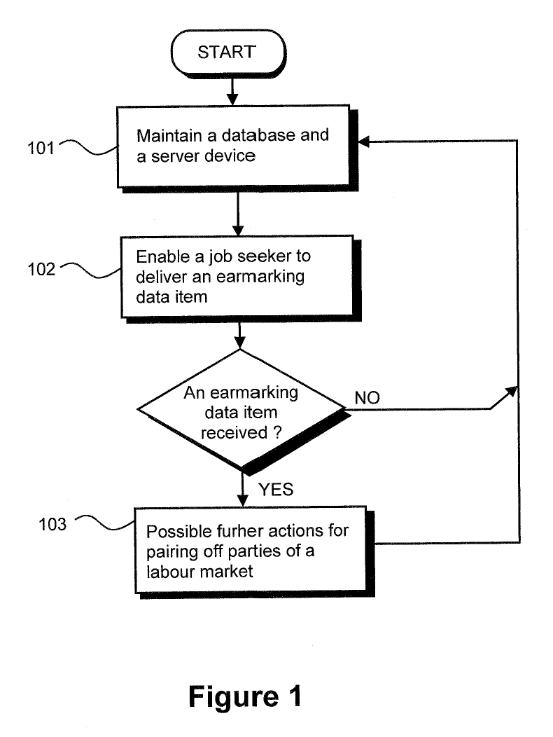

FIG. 1 shows a flow chart of a method according to an embodiment of the invention for pairing off parties on the labour market. A service provider maintains 101 a database that contains labour market data. The service provider is a party that provides a service for pairing off parties on the labour market. The labour market data can include, for example, descriptions of potential employers that can be companies or private persons, descriptions of vacant jobs, and a list of fields of profession. Examples of the fields of profession are electrical power engineering, telecommunication engineering, chemical engineering, lawyer profession, dentistry, etc. The service provider maintains 101 a server device that connects the database to a data network. The service provider enables 102 a job seeker to deliver, via the data network to the server device, an earmarking data item that contains information about the job seeker and a logical pointer that earmarks a piece of the labour market data. The piece of the labour market data can represent, for example, a certain company or other potential employer that interests the job seeker, a certain vacant job that interests the job seeker, and/or a certain field of profession on which the job seeker wishes to find a job. The information about the job seeker can comprise, for example, the curriculum vitae (CV) of the job seeker.

The job seeker can be enabled to submit the earmarking data item without showing his/her identifying information to the public or to potential employers in order to allow the job seeker to survey anonymously the situation on the labour market.

After the earmarking data item has been delivered, possible further actions 103 for pairing off the job seeker with one or more potential employers can take place. The possible further actions can include, for example, checking the job seeker's interestedness and a delivery of contact information of the job seeker to potential employers. The service provider may charge the potential employers a fee for the delivery of the contact information of the job seeker.

In a method according to an embodiment of the invention each job seeker is required to register him/herself to the service for pairing off parties on the labour market. A job seeker can be given a user identifier (user ID) and/or a password.

In a method according to an embodiment of the invention each potential employer who wants to acquire contact information and/or other information about job seekers is required to register him/herself to the service for pairing off parties on the labour market. A potential employer can be given a user identifier (user ID) and/or a password.

In a method according to an embodiment of the invention a potential employer is enabled to order a list containing information about job seekers that have earmarked the potential employer, a vacant job of the potential employer, and/or a field of profession associated with the potential employer. The service provider may charge the potential employer a fee for a delivery of the above-mentioned list. The order of the list may be a single order or a continuous subscription such that the list is delivered during pre-determined time intervals.

In a method according to an embodiment of the invention the service provider gathers the labour market data and delivers the gathered labour market data into the database.

In a method according to an embodiment of the invention the service provider enables a potential employer to supplement the labour market data with at least one of the following: a description of the potential employer, a description of vacant jobs of the potential employer, and a list of fields of profession associated with the potential employer. The service provider may charge the potential employer a fee for a possibility to supplement the labour market data. For example, there can be a predetermined fee for a possibility to add a job advertisement.

In a method according to an embodiment of the invention the service provider enables the job seeker to amend the earmarking data item. For example, the job seeker can change, add, or delete information from the earmarking data item.

In a method according to an embodiment of the invention the labour market data is delivered into the database by potential employers, each potential employer delivering at least one of the following: a description of the potential employer, a description of vacant jobs of the potential employer, a list of fields of profession associated with the potential employer. The service provider may charge the potential employer a fee for a possibility to deliver a piece of the labour market data.

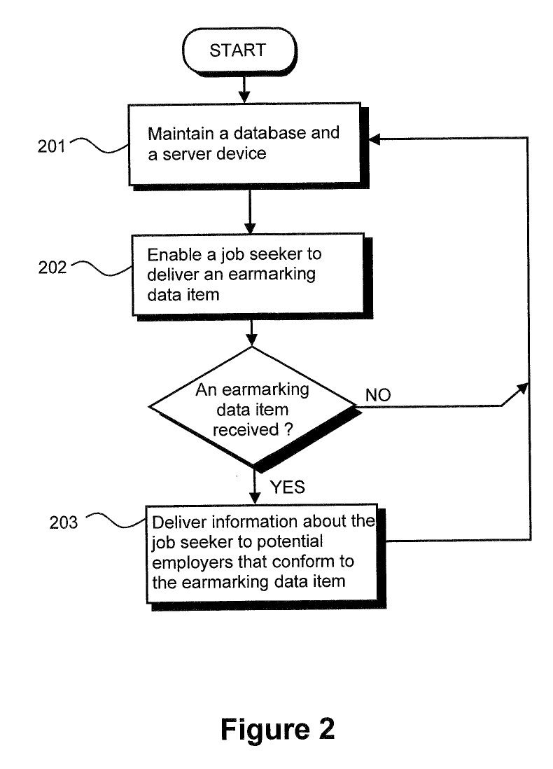

FIG. 2 shows a flow chart of a method according to an embodiment of the invention for pairing off parties on the labour market. A service provider maintains 201 a database that contains labour market data and a server device that connects the database to a data network. The service provider enables 202 a job seeker to deliver, via the data network to the server device, an earmarking data item that contains information about the job seeker and a logical pointer that earmarks a piece of the labour market data.

After the earmarking data item has been delivered, the service provider delivers 203 information about the job seeker to those potential employers that conform to the earmarking data item. A potential employer conforms to the earmarking data item, for example, in the following situations:
the earmarking data item earmarks the potential employer,
the earmarking data item earmarks a vacant job of the potential employer, and/or
the earmarking data item earmarks a field of procession that is associated with the potential employer, e.g. electrical power engineering is associated with a company that produces electrical motors.

In a method according to an embodiment of the invention the service provider selects the potential employers that conform to the earmarking data item, i.e. that correspond with the piece of the labour market data earmarked by the logical pointer. For example, if the earmarked piece of the labour market data indicates a field of chemical engineering, the service provider may select such potential employers that develop and/or produce chemical products.

In a method according to an embodiment of the invention, for each piece of the labour market data there is a pre-determined association with at least one potential employer. The pre-determined associations are used for determining the potential employers that conform to the earmarking data item. Certain pieces of the labour market data are inherently associated with a potential employer, e.g. a piece of the labour market data describing a company or other potential employer or a piece of the labour market data describing a vacant job of a potential employer. On the other hand, certain other pieces of the labour market data are not inherently associated with a potential employer, e.g. a piece of labour market data defining a field of profession. In this case the pre-determined association between the piece of labour market data and a potential employer has to be created by the service provider.

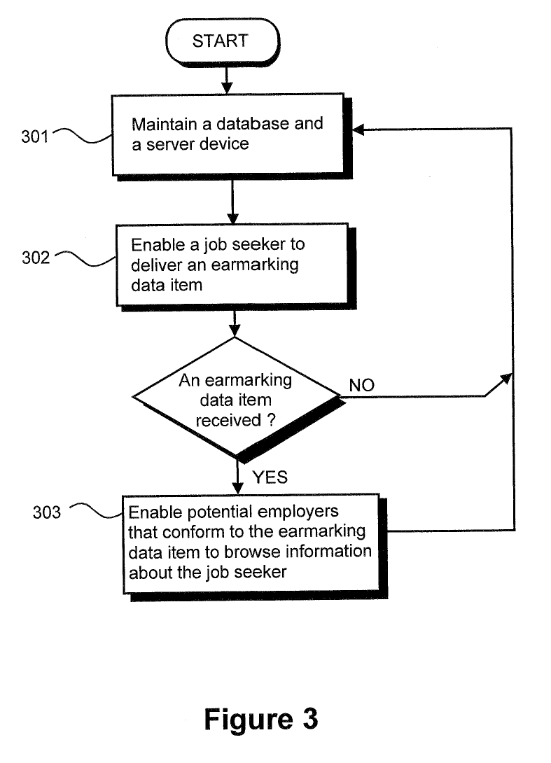

FIG. 3 shows a flow chart of a method according to an embodiment of the invention for pairing off parties on the labour market. A service provider maintains 301 a database that contains labour market data and a server device that connects the database to a data network. The service provider enables 302 a job seeker to deliver, via the data network to the server device, an earmarking data item that contains information about the job seeker and a logical pointer that earmarks a piece of the labour market data.

After the earmarking data item has been delivered, the service provider enables 303 potential employers that conform to the earmarking data item to browse information about the job seeker. A potential employer can be enabled to browse the information about the job seeker, for example, by defining a status of a user identifier (user ID) of the potential employer to be eligible to access to the information about the job seeker.

In a method according to an embodiment of the invention the service provider selects the potential employers that conform to the earmarking data item, i.e. that correspond with the piece of the labour market data earmarked by the logical pointer.

In a method according to an embodiment of the invention, for each piece of the labour market data there is a pre-determined association with at least one potential employer. The pre-determined associations are used for determining the potential employers that conform to the earmarking data item.

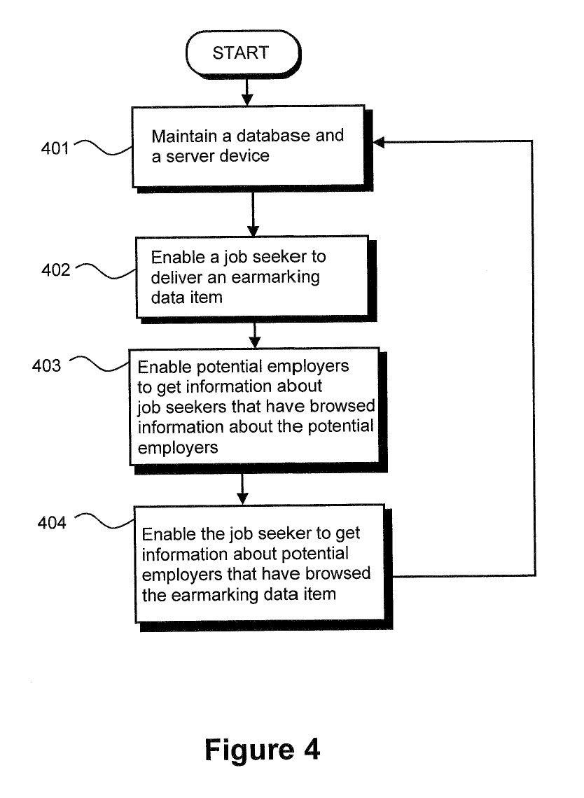

FIG. 4 shows a flow chart of a method according to an embodiment of the invention for pairing off parties on the labour market. A service provider maintains 401 a database that contains labour market data and a server device that connects the database to a data network. The service provider enables 402 a job seeker to deliver, via the data network to the server device, an earmarking data item that contains information about the job seeker and a logical pointer that earmarks a piece of the labour market data.

The service provider enables 403 a potential employer to get information about job seekers that have browsed those pieces of the labour market data that are associated with the potential employer and the service provider enables 404 the job seeker to get information about potential employers that have browsed the earmarking data item.

The above-mentioned information about the job seekers can comprise for example:
fields of profession of the job seekers,
a distribution of educational levels of the job seekers, e.g. percentages of job seekers having an university degree, a vocational school background, a primary school background, etc,
an age distribution of the job seekers, and/or
a distribution of lengths of working experience of the job seekers.

The service provider may charge the potential employer a fee for a possibility to get the above-mentioned information.

In a method according to an embodiment of the invention a job seeker is enabled to determine which part of the information presented in an earmarking data item is presented as a part of the above-mentioned information. The earmarking data item can contain e.g. parameters with the aid of which the job seeker can allow or prevent the presentation of certain parts of the information presented in the earmarking data item. For example, the job seeker may want to show his or her name only to those potential employers that conform to the earmarking data item but not to those potential employers whose information has only been browsed by the job seeker.

The above-mentioned information about the potential employers can comprise for example:
a list of names and fields of business of the potential employers, and/or
a list of vacant jobs of the potential employers and for each vacant job a list of desired properties of a job seeker,
a distribution of desired educational levels for the vacant jobs, and/or
a distribution of desired lengths of working experience for the vacant jobs.

The service provider may charge a job seeker a fee for a possibility to get the above-mentioned information, but usually the services should be free for a job seeker.

In a method according to an embodiment of the invention a potential employer is enabled to browse partial information about the job seekers free and to order more complete information about the most interesting job seekers. The service provider may charge the potential employer a fee for a delivery of the more complete information about the most interesting job seekers.

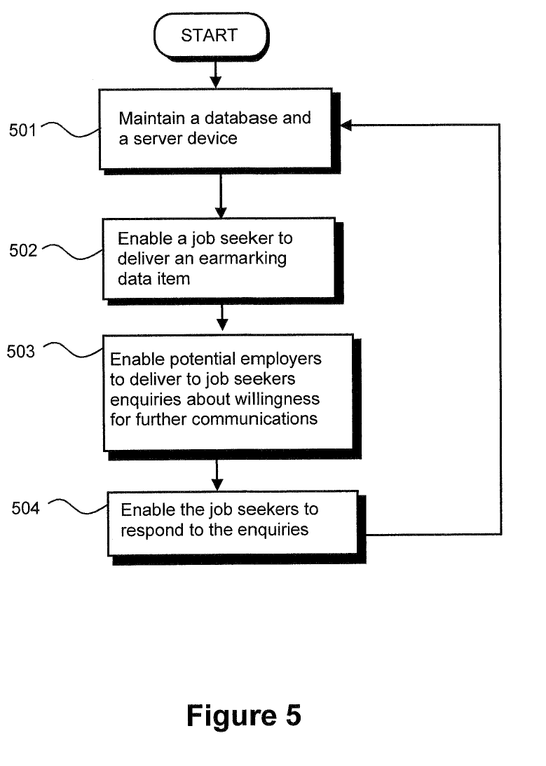

FIG. 5 shows a flow chart of a method according to an embodiment of the invention for pairing off parties on the labour market. A service provider maintains 501 a database that contains labour market data and a server device that connects the database to a data network. The service provider enables 502 a job seeker to deliver, via the data network to the server device, an earmarking data item that contains information about the job seeker and a logical pointer that earmarks a piece of the labour market data.

The service provider enables 503 a potential employer to send to job seekers, whose earmarking data items indicate interestedness in a field of profession associated with the potential employer, general enquiries about willingness for further communications. The service provider may charge the potential employer a fee for the possibility to send the above-mentioned enquiries. The service provider enables 504 the job seekers to respond to the above-mentioned general enquiries. The service provider may charge the potential employer a fee for the possibility to receive the responses of the job seekers. The service provider may check the responses of the job seekers and remove impertinent job seekers from the service.

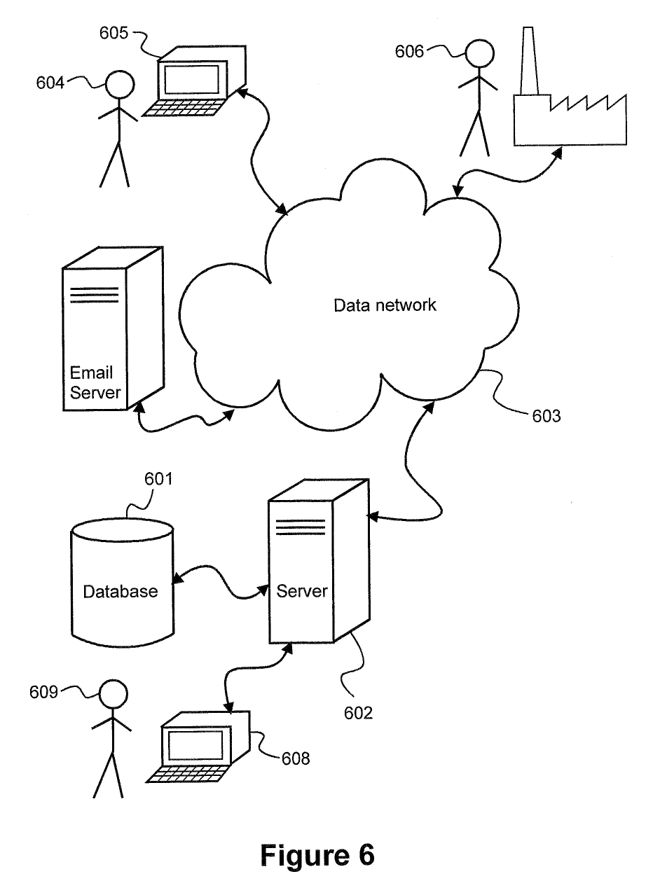

FIG. 6 shows an arrangement according to an embodiment of the invention for pairing off parties on the labour market. The arrangement comprises a database 601 and a server device 602. The database is arranged to store labour market data and the service device is arranged to connect the database to a data network 603. The data network 603 can be for example the Internet. The server device 602 is arranged to enable a job seeker 604 to deliver, via the data network 603 to the server device 602, an earmarking data item that contains information about the job seeker and a logical pointer earmarking a piece of the labour market data. The earmarking data item can be stored in the database 601 or there can be a separate database for earmarking data items. The service provider 609 can control the arrangement using a user interface of a terminal device 608 that is connected to the server device 602.

The job seeker 604 generates the earmarking data item using a user interface of a terminal device 605 connected to the data network 603. The earmarking data item is transferred to the server device 602 via the data network. Data transfer between the terminal device 605 and the server device 602 can be arranged, for example, with the aid of the common electrical mail service. The server device is adapted to compare the logical pointer of the earmarking data item with the labour market data and to perform possible further actions for pairing off the job seeker with one or more potential employers 606. The possible further actions can include, for example, a delivery of contact information of the job seeker to potential employers that conform to the earmarking data item, i.e. the earmarking data item earmarks a potential employer, the earmarking data item earmarks a vacant job of the potential employer, and/or the earmarking data item earmarks a field of procession that is associated with the potential employer.

In an arrangement according to an embodiment of the invention an encrypted data transfer protocol is used between the service provider 609 and the job seeker 604 and between the service provider and the potential employer 606.

In an arrangement according to an embodiment of the invention a piece of the labour market data comprises at least one of the following: a description of a potential employer 606, a description of a vacant job, and a list of fields of profession.

In an arrangement according to an embodiment of the invention the server device 602 is arranged to enable a potential employer 606 to supplement the labour market data with at least one of the following: a description of the potential employer, a description of vacant jobs of the potential employer, and a list of fields of profession associated with the potential employer.

In an arrangement according to an embodiment of the invention the server device 602 is arranged to enable potential employers to deliver the labour market data into the database, each potential employer being enabled to deliver at least one of the following: a description of the potential employer, a description of vacant jobs of the potential employer, a list of fields of profession associated with the potential employer.

In an arrangement according to an embodiment of the invention the server device 602 is arranged to select potential employers that correspond with the piece of the labour market data earmarked by the logical pointer and to deliver the information about the job seeker to the selected potential employers.

In an arrangement according to an embodiment of the invention the server device 602 is arranged to select potential employers that correspond with the piece of the labour market data earmarked by the logical pointer and to enable the selected potential employers to browse the information about the job seeker.

In an arrangement according to an embodiment of the invention the server device 602 is arranged to associate each piece of the labour market data with at least one potential employer and to deliver the information about the job seeker to potential employers that are associated with the piece of the labour market data earmarked by the logical pointer.

In an arrangement according to an embodiment of the invention the server device 602 is arranged to associate each piece of the labour market data with at least one potential employer and to enable potential employers that are associated with the piece of the labour market data earmarked by the logical pointer to browse the information about the job seeker.

In an arrangement according to an embodiment of the invention the server device 602 is arranged to enable the job seeker 604 to amend the earmarking data item.

In an arrangement according to an embodiment of the invention the server device 602 is arranged to enable the job seeker 604 to get information about potential employers that have browsed the earmarking data item.

In an arrangement according to an embodiment of the invention the server device 602 is arranged to enable the potential employer 606 to get information about job seekers that have browsed those pieces of the labour market data that are associated with the potential employer.

In an arrangement according to an embodiment of the invention the server device 602 is arranged to enable the potential employer 606 to deliver to the job seeker 604 an enquiry about willingness for further communications as a response to a situation in which the earmarking data item indicates interestedness for a field of profession associated with the potential employer.

In an arrangement according to an embodiment of the invention the server device 602 is arranged to enable the job seeker 604 to, respond to the enquiry delivered by potential employer 606.

The server device 602 is preferably a programmable computer that is equipped with a computer program product according to an embodiment of the invention.

A computer program product, embodied in a computer readable medium, according to an embodiment of the invention comprises:
computer program means for making the server device 602 to maintain a database 601 arranged to store labour market data,
computer program means for making the server device 602 to connect the database 601 to the data network 603, and
computer program means for making the server device 602 to enable the job seeker 604 to deliver, via the data network to the server device, an earmarking data item that contains information about the job seeker and a logical pointer earmarking a piece of the labour market data.

The computer program means can be, for example, subroutines and/or functions of a computer program. The computer readable medium can be, for example, an optical compact disc (CD), a magnetic hard disc, or an electronic memory device like a RAM (Random Access Memory).

While there have been shown and described and pointed out fundamental novel features of the invention as applied to embodiments thereof, it will be understood that various omissions and substitutions and changes in the form and details of the method and the arrangement described may be made by those skilled in the art without departing from the spirit of the invention. For example, it is expressly intended that all combinations of those method steps and arrangement elements which perform substantially the same function in substantially the same way to achieve the same results are within the scope of the invention. Moreover, it should be recognized that method steps and arrangement elements shown and/or described in connection with any disclosed form or embodiment of the invention may be incorporated in any other disclosed or described or suggested form or embodiment as a general matter of design choice. It is the intention, therefore, to be limited only as indicated by the spirit of the independent claims appended hereto. The specific examples provided in the description given above should not be construed as limiting. Therefore, the invention is not limited merely to the embodiments described above, many variants being possible without departing from the spirit of the inventive idea defined in the independent claims.

What is claimed is:

1. A method for pairing off parties on a labour market, wherein:
a service provider maintains a database arranged to store labour market data and a server device arranged to connect the database to a data network, and
the service provider enables a job seeker to deliver, via the data network to the server device, an earmarking data item that contains information about the job seeker and a logical pointer that earmarks a piece of the labour market data.

2. A method according to claim 1, wherein the piece of the labour market data comprises at least one of the following: a description of a potential employer, a description of a vacant job, and a list of fields of profession.

3. A method according to claim 1, wherein the labour market data is delivered into the database by the service provider.

4. A method according to claim 3, wherein the service provider enables a potential employer to supplement the labour market data with at least one of the following: a description of the potential employer, a description of vacant jobs of the potential employer, and a list of fields of profession associated with the potential employer.

5. A method according to claim 1, wherein the labour market data is delivered into the database by potential employers, each potential employer delivering at least one of the following: a description of the potential employer, a description of vacant jobs of the potential employer, a list of fields of profession associated with the potential employer.

6. A method according to claim 1, wherein the service provider selects potential employers that correspond with the piece of the labour market data earmarked by the logical pointer and delivers the information about the job seeker to said potential employers.

7. A method according to claim 1, wherein the service provider selects potential employers that correspond with the piece of the labour market data earmarked by the logical pointer and enables said potential employers to browse the information about the job seeker.

8. A method according to claim 1, wherein for each piece of the labour market data, there is a pre-determined association with at least one potential employer and the service provider delivers the information about the job seeker to potential employers that are associated with the piece of the labour market data earmarked by the logical pointer.

9. A method according to claim 1, wherein for each piece of the labour market data, there is a pre-determined association with at least one potential employer and the service provider enables potential employers that are associated with the piece of the labour market data earmarked by the logical pointer to browse the information about the job seeker.

10. A method according to claim 1, wherein the service provider enables the job seeker to amend the earmarking data item.

11. A method according to claim 1, wherein the service provider enables the job seeker to get information about potential employers that have browsed the earmarking data item.

12. A method according to claim 1, wherein the service provider enables a potential employer to get information about job seekers that have browsed those pieces of the labour market data that are associated with the potential employer.

13. A method according to claim 1, wherein the service provider enables a potential employer to deliver to the job seeker an enquiry about willingness for further communications as a response to a situation in which the earmarking data item indicates interest in a field of profession associated with the potential employer.

14. A method according to claim 13, wherein the service provider enables the job seeker to respond to the enquiry delivered by potential employer.

15. An arrangement for pairing off parties on a labour market, the arrangement comprising:
a database arranged to store labour market data, and
a server device arranged to connect the database to a data network,
wherein the server device is arranged to enable a job seeker to deliver, via the data network to the server device, an earmarking data item that contains information about the job seeker and a logical pointer earmarking a piece of the labour market data.

16. An arrangement according to claim 15, wherein the piece of the labour market data comprises at least one of the following: a description of a potential employer, a description of a vacant job, and a list of fields of profession.

17. An arrangement according to claim 15, wherein the server device is arranged to enable a potential employer to supplement the labour market data with at least one of the following: a description of the potential employer, a description of vacant jobs of the potential employer, and a list of fields of profession associated with the potential employer.

18. An arrangement according to claim 15, wherein the server device is arranged to enable potential employers to deliver the labour market data into the database, each potential employer being enabled to deliver at least one of the following: a description of the potential employer, a description of vacant jobs of the potential employer, a list of fields of profession associated with the potential employer.

19. An arrangement according to claim 15, wherein the server device is arranged to select potential employers that correspond with the piece of the labour market data earmarked by the logical pointer and to deliver the information about the job seeker to said potential employers.

20. An arrangement according to claim 15, wherein the server device is arranged to select potential employers that correspond with the piece of the labour market data earmarked by the logical pointer and to enable said potential employers to browse the information about the job seeker.

21. An arrangement according to claim 15, wherein the server device is arranged to associate each piece of the labour market data with at least one potential employer and to deliver the information about the job seeker to potential employers that are associated with the piece of the labour market data earmarked by the logical pointer.

22. An arrangement according to claim 15, wherein the server device is arranged to associate each piece of the labour market data with at least one potential employer and to enable potential employers that are associated with the piece of the labour market data earmarked by the logical pointer to browse the information about the job seeker.

23. An arrangement according to claim 15, wherein the server device is arranged to enable the job seeker to amend the earmarking data item.

24. An arrangement according to claim 15, wherein the server device is arranged to enable the job seeker to get information about potential employers that have browsed the earmarking data item.

25. An arrangement according to claim 15, wherein the server device is arranged to enable a potential employer to get information about job seekers that have browsed those pieces of the labour market data that are associated with the potential employer.

26. An arrangement according to claim 15, wherein the server device is arranged to enable a potential employer to deliver to the job seeker an enquiry about willingness for further communications as a response to a situation in which the earmarking data item indicates interest in a field of profession associated with the potential employer.

27. An arrangement according to claim 26, wherein the server device is arranged to enable the job seeker to respond to the enquiry delivered by potential employer.

28. A computer program product, embodied in a computer readable medium, for pairing off parties on a labour market, the computer program product comprising:
computer program means for making a server device to maintain a database arranged to store labour market data,
computer program means for making the server device to connect the database to a data network, and
computer program means for making the server device to enable a job seeker to deliver, via the data network to the server device, an earmarking data item that contains information about the job seeker and a logical pointer earmarking a piece of the labour market data.
